(19) United States
(12) Patent Application Publication
(10) Pub. No.: US 2010/0060451 A1
(43) Pub. Date: Mar. 11, 2010

(54) GIFT BAG WITH MOVEMENT SENSOR AND ALARM

(75) Inventors: Gretchen G. Finch, Kansas City, MO (US); Susan Kathleen Klopfenstein, Prairie Village, KS (US); Molly Ann Hupke, Parkville, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HALLMARK CARDS, INCORPORATED, Kansas City, MO (US)

(21) Appl. No.: 12/208,800

(22) Filed: Sep. 11, 2008

(51) Int. Cl. G08B 13/00; G08B 3/10

(52) U.S. Cl. 340/541; 340/384.4

(57) ABSTRACT

A gift bag having an audio message playback device is activate by a motion detector to play an audio message upon detection of movement of the gift bag or in the vicinity of the gift bag. The gift bag includes a plurality of side walls and a bottom to define an interior for receiving a gift. The audio message, played upon the detection of movement of or in the vicinity of the gift bag, may include siren noises, music and/or spoken messages.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

The present invention relates to a gift bag. More particularly, this invention relates to a gift bag having an audio playback device that is activated by a motion detector. In today's fast paced world, the popularity of gift bags, in comparison to the traditional wrapping of a gift using wrapping paper, has increased significantly. The ability to quickly place a gift therein, add some tissue paper and be done with the wrapping process is attractive to many consumers. The gift bags, however, still remain open at the top where someone could look into the gift bag to see the gift before the intended time for opening of the package. Accordingly, the present invention provides the gift bag with an audio message that is played upon sensing movement of the bag or movement in the vicinity of the bag. This audio message alerts others in the area of a possible “unauthorized” opening of the bag and provides the bag with a unique and unexpected feature that enhances the entertainment qualities of the gift bag.

The gift bag can be of standard construction having four walls and a bottom to provide a space for a user to locate a gift. The bag can also have a pair of handles to permit easy carrying of the gift bag. An audio playback device is provided with the gift bag that includes a motion detector which provides activation of the audio playback device. The audio playback device includes a speaker for playing back a message stored in a memory component of the audio playback device. A power source is provided for powering the audio playback device and a switch may be provided for deactivating or turning off the audio playback device. In an alternate embodiment, the audio playback device may also include a microphone and a record feature to allow a purchaser of the gift bag to record their own message that is played upon activation of the audio playback device.

Further objects, features and advantages of the present invention over the prior art will become apparent from the detailed description of the drawings which follows, when considered with the attached figures.

### BRIEF DESCRIPTION OF THE SEVERAL VIEWS OF THE DRAWING

The features of the invention noted above are explained in more detail with reference to the embodiments illustrated in the attached drawing figures, in which like reference numerals denote like elements, in which FIGS. 1-4 illustrate one possible embodiment of the present invention, and in which:

FIG. 1 is a perspective view of a user activating an alarm of a gift bag constructed in accordance with an embodiment of the present invention by moving the same;

FIG. 2 is a perspective view of one possible design of a gift bag constructed in accordance with an embodiment of the present invention;

FIG. 3 is a side elevation of gift bag of FIG. 2; and

FIG. 4 is a fragmentary side elevation of an interior of the gift bag of FIG. 3 with a portion of a cover panel cut-away to reveal electrical components of the gift bag.

### DETAILED DESCRIPTION OF THE INVENTION

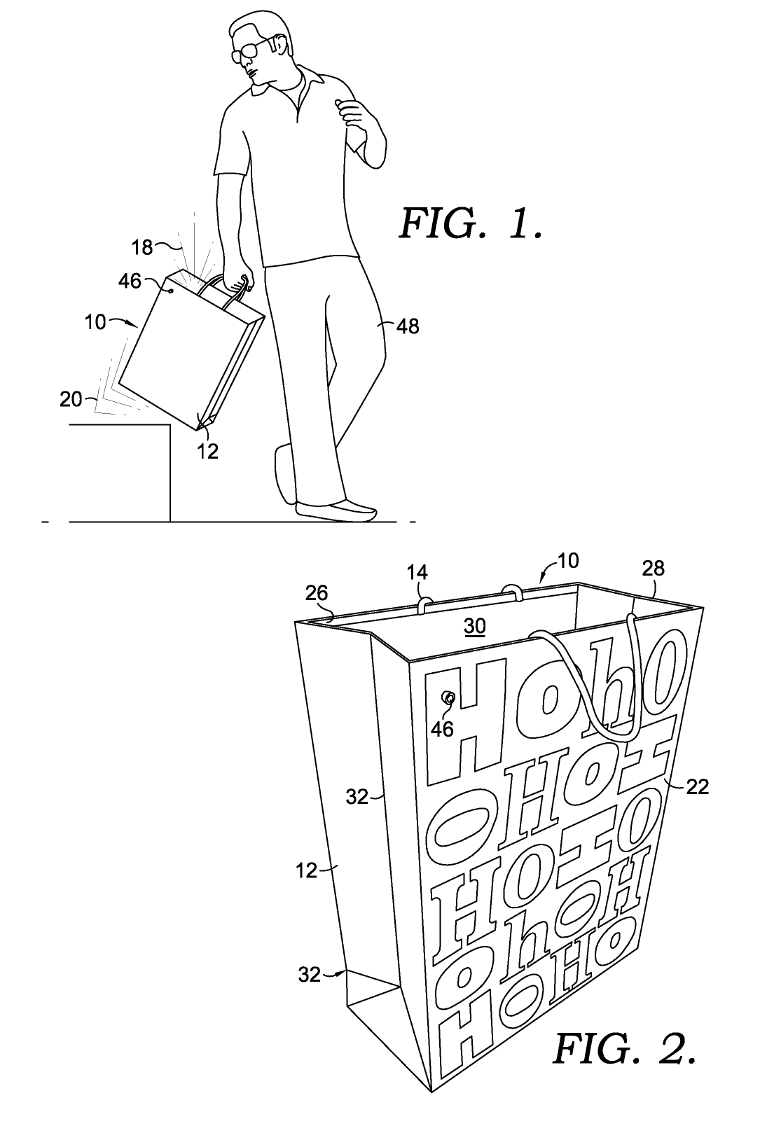

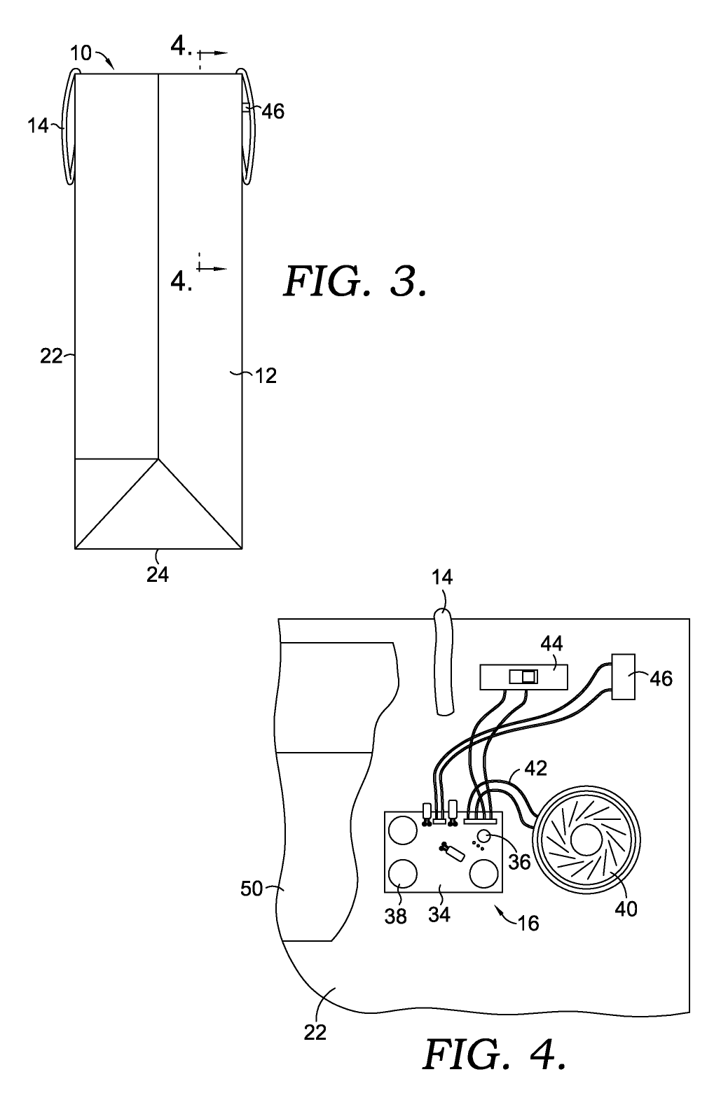

Referring now to the drawings in more detail and initially to FIG. 1, numeral 10 generally designates a gift bag constructed in accordance with an embodiment of the present invention. The gift bag 10 includes a bag body 12 and a pair of handles 14. An audio playback device 16 is coupled with the gift bag 10 to provide sound 18 in the form of an audio message or alert upon activation of the audio playback device 16 as a result of detecting movement 20 of or in the vicinity of the gift bag 10.

The bag body 12 can have any construction known in the art. In the illustrated embodiment, the bag body 12 includes a plurality of side walls or side panels 22 connected to or integrally formed with a bottom panel 24. The side walls 22 cooperate to define an opening 26 adjacent an upper periphery 28 of the side walls 22 to permit access to an interior 30 of the bag body 12 that is defined by the side walls 22 and the bottom 24.

Opposing panels 22 may be provided with a vertical crease 32 to permit folding of the gift bag 10 in a manner known in the art. Similarly, a transverse crease 32 may be provided across one of the panels 22 to permit folding of the bottom 24 upward for storage for the gift bag 10 in a flat or collapsed position.

The audio playback device 16 can be any electronic device capable of storing and playing back an audio message upon activation. In the illustrated embodiment, the audio playback device 16 includes a circuit board 34 onto which is mounted an integrated circuit or chip 36 and one or more batteries 38 for powering the audio playback device 16. A speaker 40 is electrically coupled with the circuit board 34 by, in the illustrated embodiment, a plurality of wires 42. Also electrically coupled with the circuit board 34 is a power switch 44 and a motion detector 46.

In the illustrated embodiment, the integrated circuit 36 includes a memory component which stores an audio message for playback upon activation of the audio playback device 16. The power switch 44 provides a user with the ability to selectively turn the audio playback device 16 on or off to conserve battery life or prevent activation of the audio playback device during filling of or “authorized” transportation of the gift bag 10. The sound or audio message 18 can be any type of sound or audio message including, but not limited to, a siren sound, music, and/or spoken words. To provide the gift bag 10 with an increased amusement level, the audio message 18 may include a spoken message advising people in the vicinity of the gift bag 10 that an “unauthorized” peek inside the bag has been detected and instructing the person 48 whose movement was detected and triggered activation of the audio playback device 16 to “step away from the bag!” in an official sounding voice.

In an alternate embodiment, the audio playback device 16 may also be provided with a microphone (not shown) and a record button (not shown) to permit a purchaser of the gift bag 10 to record their own message on the audio playback device 16 that is played back either alone or in combination with a pre-recorded message upon activation of the audio playback device 16.

In use, a purchaser of the gift bag 10, for example, a parent, expands the bag body 12 to the open position illustrated in FIG. 2, and inserts a gift into the interior 30 of the bag body 12 through the opening 26 in the manner customary in the art. The parent can then cover the gift (not shown) with tissue paper to obstruct the gift from view through the opening 26. The parent may then “arm” the audio playback device 16 by switching on the power to the audio playback device 16 by using the power switch 44. The gift bag 10 is then placed in a desired location.

When the motion detector 46 senses or detects movement 20 of the gift bag 10 or in the vicinity of the gift bag 10, the motion detector 46 activates the audio playback device 16 which in turn initiates playback of the sound or recorded message via the speaker 40. It should be understood that the term “motion detector” is to be broadly defined as any item or device that can detect movement of the bag (such as motion switch which activates upon movement), in the vicinity of the bag (such as a device that detects changes in light), or both.

Many variations can be made to the illustrated embodiment of the present invention without departing from the scope of the present invention. Such modifications are within the scope of the present invention. For example, while the audio playback device 16 may be coupled with the gift bag 10 in a manner that allows the audio playback device 16 to be visible, in the illustrated embodiment, the audio playback device 16 is hidden from view by placing it behind an interior flap or cover panel 50 while the audio playback device is mounted on an interior of one of the side walls 22 adjacent an upper edge. The motion detector 46 may then be positioned such that a portion thereof passes through an opening in one of the side walls 22 of the bag body 12. Other modifications would be within the scope of the present invention.

From the foregoing it will be seen that this invention is one well adapted to attain all ends and objects hereinabove set forth together with the other advantages which are obvious and which are inherent to the method and apparatus. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A gift bag comprising:
a bag body having a plurality of sidewalls, a bottom and a pair of handles, wherein the bag body defines a cavity for receiving a gift;
an audio message playback device coupled with the bag body, the device having a memory component with at least one audio message stored therein, a speaker for playing the at least one audio message, and a power source; and
a motion detector, wherein the motion detector activates the audio message playback device when movement of the bag body or in the vicinity of the bag body is detected.

2. The gift bag of claim 1, wherein the audio message is selected from a group including a voice command, a siren, and music.

3. The gift bag of claim 2, wherein the voice command is a warning message instructing a user who activated the audio message playback device to not look inside the bag body.

4. The gift bag of claim 2, wherein the voice command is an alert message informing people in the vicinity of the bag body that movement has been detected of the bag body or in the vicinity of the bag body.

5. The gift bag of claim 1, wherein the audio message playback device further includes a first switch electrically coupled with the power source to permit a user to selectively deactivate the audio message playback device.

6. The gift bag of claim 1, wherein the audio message playback device further includes a microphone and a record button for permitting a user to record their own audio message and store the same in the memory component.

7. The gift bag of claim 6, wherein user recorded message is played in addition to a pre-recorded message.

8. A gift bag with movement sensor and alarm comprising:
a bag body having a plurality of side panels and a bottom all connected together to define a cavity for receiving a gift, wherein the side panels also define an opening adjacent an upper end of the bag body, and wherein the opening provides access to the cavity;
an audio message playback device coupled with the bag body, the device having a circuit board, an integrated circuit with a memory component having at least one audio message stored therein, a speaker for playing the at least one audio message, a battery and a power switch; and
a motion detector electrically coupled with the audio message playback device, wherein the motion detector activates the audio message playback device when movement of the bag body or in the vicinity of the bag body is detected.

9. The gift bag of claim 8, wherein the audio message is selected from a group including a voice command, a siren, and music.

10. The gift bag of claim 9, wherein the voice command is a warning message instructing a user who activated the audio message playback device to not look inside the bag body.

11. The gift bag of claim 9, wherein the voice command is an alert message informing people in the vicinity of the bag body that movement has been detected of the bag body or in the vicinity of the bag body.

12. The gift bag of claim 8, wherein the bag body further includes a cover panel inside the cavity and adjacent a side panel, wherein the audio message playback device is positioned between the cover panel and the side panel and is obstructed from view by a user, and wherein a portion of the motion detector passes through an opening in one of the side panels of the bag body.

13. The gift bag of claim 8, wherein the audio message playback device further includes a microphone and a record button for permitting a user to record their own audio message and store the same in the memory component.
